(19) United States
(12) Patent Application Publication
(10) Pub. No.: US 2007/0229650 A1
(43) Pub. Date: Oct. 4, 2007

(54) Mobile communications terminal and method therefor

(75) Inventor: Michael McKay, Frederiksberg (DK)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/392,927

(22) Filed: Mar. 30, 2006

(51) Int. Cl. H04N 7/14

(52) U.S. Cl. 348/14.01; 345/1.1

(57) ABSTRACT

A mobile communications terminal (201) for optical projecting of a media content (202) comprises means (203), which are arranged for receiving (401) an incoming communication having the media content (202), a light emitting projector (204), which is arranged to present (402) an image (205) of the media content (202) onto an object (206) and, means (207) for detecting (403) predetermined motions of the object (206), which detection of motions is used for controlling a plurality of operations of the mobile communication terminal (201).

### FIELD OF THE INVENTION

This invention relates to a method and device for optical projecting of a media content onto an external object.

### BACKGROUND OF THE INVENTION

Mobile communication terminals are used on the go, practically everywhere. Most often, the terminal is equipped with a built-in display used for presentation of all kinds of data and information. Portability has lead to increased flexibility, we take our work and private matters where we go.

A growing concern is how to preserve privacy when communicating with others. One such privacy issue arises when we access media content, such as SMS, in crowded environments and not want others to view the content. There need not be any harmful thoughts behind viewing the contents of other's handheld devices. Curiosity, or just innocent mindlessness letting our eyes rest at just anything nearby may be just as annoying for anyone wanting to keep something for themselves. Hence, it is a growing concern to preserve privacy while viewing content from a mobile phone. There is also a need for alternative visualization methods of the contents comprised in a communication terminal.

Immediate solutions at hand include covering the display as good as possible given the situation we are in. For instance, one could put a physical cover around the display of the handheld device if privacy is needed.

However, shortcomings of these and other methods have discouraged many people to use their handheld devices in a wide range of public places and other situations where it is preferred to utilize discretion.

International patent application WO 02/05518, which is hereby incorporated in its entirety, discloses a cellular phone with a built-in optical projector for display of data. It deals with the problem of viewing information on small built-in displays in cellular phones. As an alternative to existing solutions, it suggests providing a projection on an external surface resulting in a significantly larger image than that of a conventional built-in display. With this document in hand, one solution, could be to switch the visualization of content information from the built-in display to an external surface such as a desk, wall or sheet of paper as suggested from international patent application WO 02/05518.

Hence, none of the suggested provide a convenient, flexible solution to the privacy issues brought forward.

Furthermore, with regards to answering incoming phone calls, current cellular phones normally produce identification of the caller on the display, whereby an action is performed by a user of the cellular phone is carried out in order to answer the call. Examples include pressing a TALK button, which requires looking at the button or searching for it by feel, or opening a flip cover, which can be awkward to achieve with one hand, especially when the user is already engaged in another task. Hence, there exists a need for alternative ways of obtaining information about an incoming call.

There is also a need to improve user-friendliness of the often technical character of user interfaces, and especially to develop more intuitive ways for reviewing information as provided by mobile communication terminals.

### SUMMARY OF THE INVENTION

An object of the present invention is to provide a method for optical projection of a media content with a mobile communication terminal.

It is particular an objective to provide a communication terminal that is capable of establishing interaction with an external object, and enabling the mobile communication terminal to utilize the external object for displaying any requested information.

It is a particular objective to provide an attractive and convenient way of presenting information such as contents of SMS or MMS while, at the same time, preserving the user's privacy.

It is furthermore an object of the invention to provide a convenient and privacy preserving way of presenting identification information of the caller of an incoming call.

A particular advantage of the present invention is to provide improved ease of use when accessing and reviewing information from a mobile phone, especially in situations where its user has limited ability to protect the displayed information.

A further advantage of the invention is the detection of predetermined motions for controlling the presentation. A further advantage of the present invention is the provision of proximity detection for activating the presentation of information.

The above object, advantage and feature together with numerous other objects, advantages and features, which will become evident from below detailed description, are obtained according to a first aspect of the present invention by a method for optical projection of a media content with a mobile communication terminal comprising the steps of:

receiving an incoming communication having a media content;

activating a light emitting projector to present an image of said media content from said mobile communication terminal onto said object; and

detecting predetermined motions of the object for controlling a plurality of operations of the mobile communication terminal.

The invention enables easy and privacy preserved presentation of information from a mobile communication terminal. Thus, a user may view information in any situation where otherwise, it would have been difficult to avoid revealing it to others.

According to one embodiment of the present invention, it comprises an additional step of detecting an object, preferably by tapping it against the mobile communication terminal. With detecting an object it is understood to encompass proximity detection of the object nearby the mobile communication terminal, pressing a button or dial of the terminal with the object, touching a sensitive display or other touch sensitive part of the terminal, or shaking, squeezing or stroking the terminal.

Alternatives to tapping comprise squeezing, shaking, stroking or applying a gentle touch to the mobile communication terminal, especially onto certain touch sensitive areas. Furthermore, the communication terminal may also be equipped with a designated button or pressure sensitive for activation of the projector.

Furthermore, the terminal may also be equipped with a proximity sensor that detects range to nearby objects so that the projector can be activated by proximity detection, rendering it enough to approach the terminal with an object without bringing them into mechanical contact. Useable proximity switches may comprise inductive, capacitative, electromagnetic radiation or ultrasonic types. Detecting electromagnetic radiation includes optical sensing and infrared radiation as detected from emitted heat from for instance, the hand of a user.

According to one embodiment of the invention, the method further comprises a step of controlling different operations of the communication terminal by recognition of predetermined motions of the object. In the case where a hand, such as the user's, is used as the object, the predetermined motions may comprise closing the hand into a fist, grabbing, waiving, pointing with one or more fingers, or like a pattern, such as comprising a series of motions. Hence, the predetermined motions may be coupled or paired with actions, commands or tasks which are executed by the communication terminal. The wording controlling is in this context also to be construed as invoking or executing different operations of the mobile communications terminal.

The predetermined motions may be recognized to control opening and/or closing items of media content, accessing previous or next item of media content in a list or stack of items, deleting an item of media content, scrolling through the content of an item of media content, answering an incoming voice call, take an action on an item selected from a list of items, call the sender of SMS or ending the projection.

The incoming communication may comprise a message, such as an SMS or MMS. As media content or message may comprise text, image, video or any combinations thereof. Although these messaging services are the most frequently used today, the invention is also intended for use with other types of text or multimedia messages.

The incoming communication may further comprise a voice call, wherein the media content may comprise a user ID. A user ID is an item of data or information revealing the identity of an incoming communication, such as a telephone number, an image of the person behind the number or similar.

The method may further comprise a step of moving the object away from the projector along a projected cone of light until a preferred size of the image is obtained. By virtually holding the information in the hand the user feel in control of the presentation, only revealing data for him or herself. The nature of the gesture is intuitive for the user getting the impression and feeling of taking the image with the hand, out of the communication terminal and after having reviewed the information, putting the it back into the terminal again.

The method may further comprise a step of moving the object back to the device and/or a step of detecting a second tap to end projection of said image. Hence, in an intuitive manner, the user will perform the same steps as when initiating the process, only in a reverse order.

The object referred to may be the hand of, for instance, a user of the communication terminal. Among the advantages of using a hand is the direct possibility of slightly folding the hand to shield off the image from the environment. Other objects that can be used comprise a newspaper, a pencil or even an umbrella.

The above objects, advantages and features together with numerous other objects, advantages and features, which will become evident from below detailed description, are obtained according to a second aspect of the present invention by a mobile communication terminal for optical projecting of a media content comprising:

means for receiving an incoming communication having a media content;

a light emitting projector arranged to present an image of said media content onto said object; and

means for detecting predetermined motions of the object for controlling a plurality of operations of the mobile communication terminal.

The means for receiving an incoming communication may be an antenna or cable transmission or similar.

The mobile communication terminal may further comprise means for detecting an object, especially a tapping of said object or any of the ways as described in connection with the related method according to the present invention. It is also within the scope of the invention to have the detection means comprising accelerometers for detecting orientation changes of the mobile communication terminal.

The mobile communication terminal may further comprise means for detecting and interpreting predetermined motions of the object, which predetermined motions are used to control different operations of the mobile communication terminal. The predetermined motions could be detected and recognized by using an image-acquiring means. An image-acquiring means could be, for instance, any type of digital camera, such as a CMOS camera.

The wording interpreting may also be interpreted as recognizing.

The light emitting projector may be comprise a laser light source. As an advantage, the laser allows the produced image to be in focus in any cross section of the produced light cone. Furthermore, the light emitting projector may be configured to interact with the external surface for adjusting the emitted light according to the structure and characteristics of the surface. Hereby, the produced image is enhanced to give the best appearance on any surface, disregarding how rough or uneven it may be.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1 shows schematically a block diagram of a mobile communication terminal according to the present invention;

FIG. 2 shows schematically a mobile communication terminal implemented according to the present invention;

FIG. 3 sections a) to e) shows schematically a user with a communication terminal according to the present invention;

FIG. 4 shows a schematic diagram of the steps in a method according to one embodiment of the invention.

### DETAQILED DESCRIPTION OF PREFERRED EMBODIMENTS

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

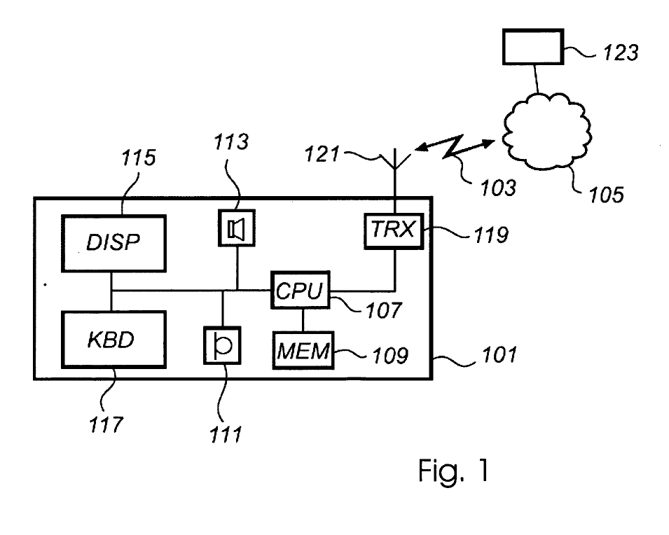

FIG. 1 illustrates schematically a communication terminal 101 in which the present invention is implemented. The terminal 101 is capable of communication via an air interface 103 with a radio communication network 105 such as the well known systems CDMA2000, D-AMPS, GSM, UMTS, EDGE, etc. The terminal comprises a processor 107, memory 109 as well as input/output units in the form of a microphone 111, a speaker 113, a display 115 and a keyboard 117. Radio communication is realized by radio circuitry 119 and an antenna 121. Connected to the radio communication network 105 is a controller 123. The details regarding how these units communicate are known to the person skilled in the art and is therefore not discussed further.

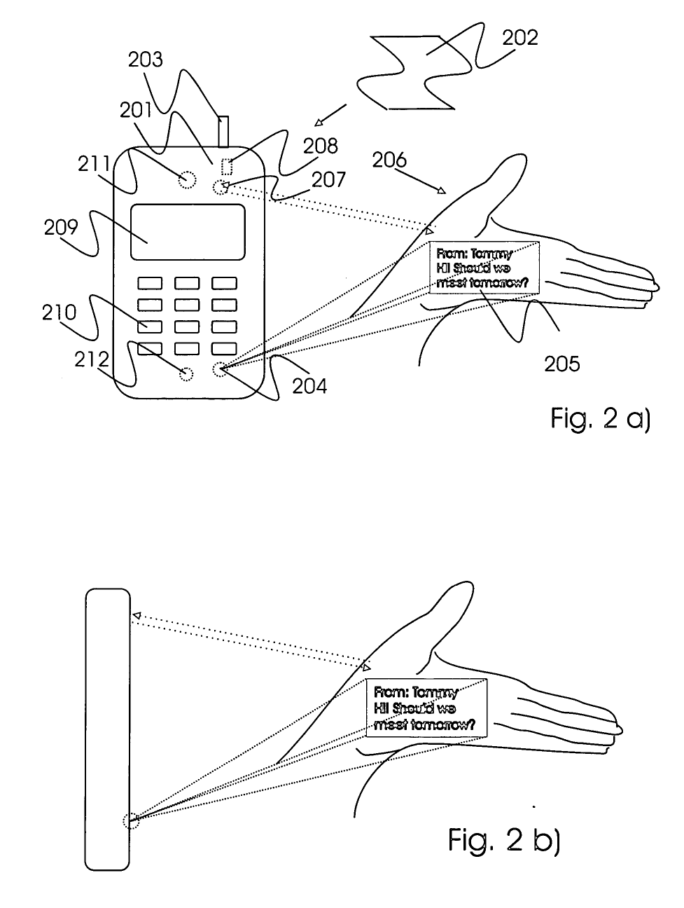

FIG. 2 section a) illustrates schematically a communication terminal 201 having a display 209 and a keypad 210. A loudspeaker 211 and a microphone 212 are indicated. The communication terminal is further equipped with a projector 204 and a detector 207 for detecting predetermined motions of an object 206. Here, the object 206 is exemplified by a hand, which inside provides a display area 205 where an image produced with the projector 204 is presented. Also depicted are an antenna 203 for receiving a media content 202. Section b) of FIG. 2 illustrates a different perspective than that shown in section a) of FIG. 2.

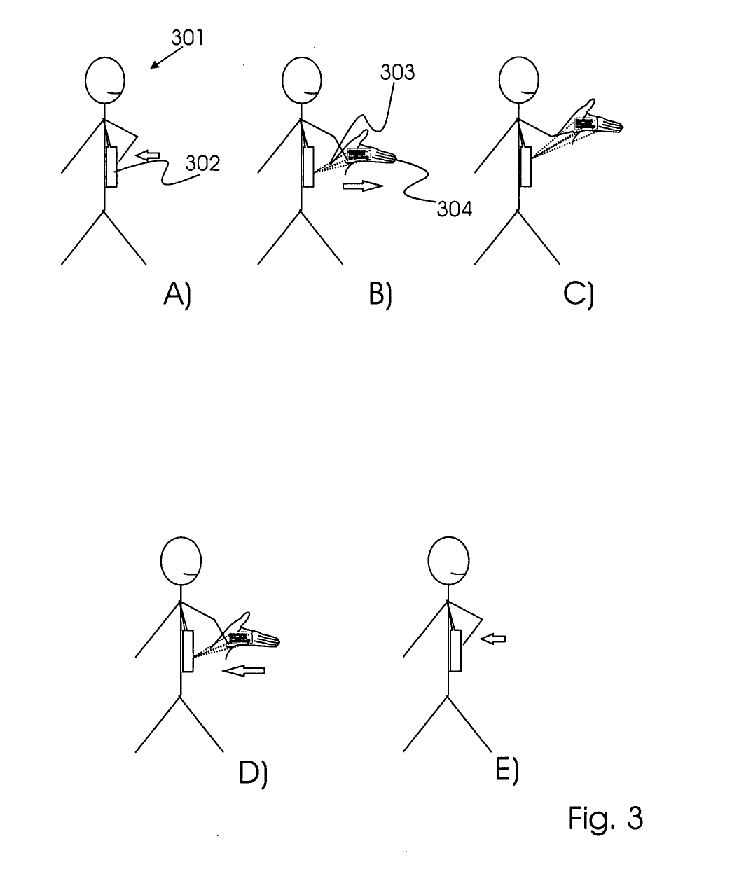

Turning now to FIG. 3, the essence of the invention may be further understood in an example where a user 301 carries a mobile phone 302 hanging on the chest in a strap around his or her neck. The user 302 may activate a projection display by covering the communication terminal with one of the hands, pressing it lightly with the center of the inside of the hand, or by tapping it as depicted in section a) of FIG. 3. A projector in the mobile phone is activated and projects a light cone 303 comprising image information. As the user moves the hand outwards from the phone as indicated in section b) of FIG. 3, an image will be produced in the hand 304. The size of the image is then easily adjusted by moving the hand back and forth along the light cone while only revealing data for him or herself. This way of starting the projector and moving the hand outwards along the light cone gives the user a sense of controlin an inutituive way asa the user experiences a feeling of grabbing an image and pulling out of the apparatus. A more technical effect apart from the property of being easy and intuitive to use and learn is that a user now has more control of where to put a screen, ie the hand, to display the projected image or display. If the projector was simply turned on the user would have to aim the projector carefully to make the projection hit the designated projection area. During the presentation as depicted in section c) of FIG. 3, the user may move the hand according to predetermined patterns, which may have been set by the user at a previous occasion, and thereby invoke different operations of the mobile phone such as calling the sender of the message, go to the next message and so forth. In section d) of FIG. 3 it is depicted how the user literally puts the picture back to the mobile phone, and in section e), taps the mobile phone a second time to end the presentation for the session. This further adds to the intuitive use of the feature making it a concept that is easy to use and learn requiring a minimum of key presses. The easiness to use is further increased as the user does not need to hit a specific key for any of the opening or closing operations. Something which is very handy if the user is in a hurry, carrying things (thereby having the hands occupied) or in a shaky, mobile environment such as an underground train system. Instead of a message, the user may view the contact information or user identification of a person from whom the user is receiving a voice call.

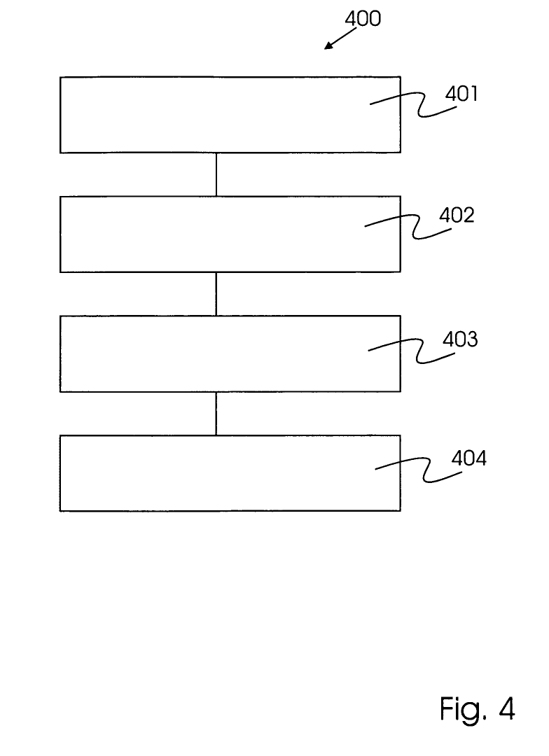

FIG. 4 shows a schematic illustration of the steps comprised in the method 400 according to the present invention. The mobile communication terminal 101 receives 401 an incoming communication having a media content 202, a light emitting projector 204 is activated 402 to present an image 205 of the media content 202 from the mobile communication terminal 200 onto an object 206 and detecting 403 predetermined motions of the object 206 for controlling a plurality of operations of the mobile communication terminal 200. According to one embodiment of the invention, there is furthermore a step of detecting 404 the object 206.

In the case where optics are utilized to present the projected image, it may be preferable to have means for adjusting the focus of the image so that the focal plane can shift for the image to be sharp at different distances from the projector. In the case where a laser is used for the projection, the rays constituting the image emitted from a point like source will never cross and therefore be in focus in any cross section.

According to one implementation of the invention, the communication terminal is configured to register and interpret motions of an object, preferably with a built-in camera combined with software that registers and analyses motions/patterns in front of it. The terminal is then configured to respond to predetermined motions or patterns of a user's hand, for instance to select and execute actions such as opening and/or closing items of media content, accessing previous or next item of media content in a list or stack of items, deleting an item of media content, scrolling through the content of an item of media content, answering an incoming voice call, take an action on an item selected from a list of items, call the sender of SMS or ending said projection.

In the case where the incoming communication is an SMS (Short Messaging Service) or MMS (Multimedia Messaging Service), the motions or patterns mentioned previously may comprise a closed fist which may be interpreted by the communication terminal to delete the message, tilting of the hand may be used to go to next message in the folder or list of messages, tilting upward may indicate going forward in the list and tilting downward going back in the list. A number of actions can be associated with different patterns by rotating, tilting, circling or simply moving the hand back and forth or up and down. A pattern may also comprise a series or sequence of motions. The communication terminal may be configured to recognize a number of pre-set motions. However, it may also be possible for a user to configure individual motions, or adjust the motions to better match existing patterns.

If the incoming communication comprises a voice call, the user then taps the communication terminal to have the user ID or phone number of the caller presented onto the external object referred to previously. The user ID may comprise a phone number, a name of the caller, a symbol or an image.

Furthermore, when the incoming communication is received, the user of the mobile communication terminal is preferably alerted, for instance, with a ring tone, vibration or light signal.

Hence, using proximity detection, a gesture of approaching the terminal with an object may trigger the terminal to activate the projector to present information of the incoming communication. A proximity sensor detects when something comes into its proximity. Such a sensor, which gives a switched output on detecting something coming into proximity, is called a proximity switch.

Finally, the above described invention provides a simple, intuitive way of reviewing information contained in a communication terminal. It is especially well suited for dynamic and active uses in for instance crowded environments such as in a bar or at a concert, but also while doing gardening with dirty hands, or rock-climbing.

1. A method (400) for optical projection of a media content with a mobile communication terminal (101) comprising the steps of:
(401) receiving an incoming communication (103) having a media content (202);
(402) activating a light emitting projector (204) to present an image (205) of said media content (202) from said mobile communication terminal (200) onto an object (206); and
(403) detecting predetermined motions of said object for controlling a plurality of operations of said mobile communication terminal.

2. A method according to claim 1, wherein said method further comprises a step of detecting (404)an object.

3. A method according to claim 2, wherein said detecting comprises a first tapping of said object.

4. A method according to claim 1, wherein said plurality of operations comprise opening and/or closing items of media content, accessing previous or next item of media content in a list or stack of items, deleting an item of media content, scrolling through the content of an item of media content, answering an incoming voice call, take an action on an item selected from a list of items, call the sender of SMS or ending said projection.

5. A method according to claim 1, wherein said incoming communication comprises a message, such as an SMS or MMS.

6. A method according to claim 1, wherein said incoming communication comprises a voice call.

7. A method according to claim 1, wherein said media content comprises text, image, video or any combinations thereof.

8. A method according to claim 1, wherein said media content comprises a user ID.

9. A method according to claim 1, wherein said method further comprises a step of (205) moving said object away from said projector along a projected cone of light until a preferred size of said image is obtained.

10. A method according to claim 1, wherein said method further comprises a step of (206) moving said object back to said device and/or a step of (207) detecting a second tap to end projection of said image.

11. A method according to claim 1, wherein said object comprises a hand of a user of said device.

12. A mobile communication terminal (201) for optical projecting of a media content (202) comprising:
means (203) for receiving an incoming communication having said media content (202);
a light emitting projector (204) arranged to present an image (205) of said media content (202) onto an object (206); and
means (207) for detecting predetermined motions of said object (206) for controlling a plurality of operations of said mobile communication terminal (201).

13. A mobile communication terminal (201) according to claim 12 further comprising means (208) for detecting said object (206).

14. A mobile communication terminal (201) according to claim 13, wherein said detecting comprises a first tap with said object (206).

15. A mobile communication terminal (201) according to claim 12, wherein said means (207) for detecting predetermined motions comprises an image detecting device such as a camera.

16. A mobile communication terminal according to claim 12, wherein said light emitting projector is a laser.
